(19) United States
(12) Patent Application Publication
(10) Pub. No.: US 2016/0374378 A1
(43) Pub. Date: Dec. 29, 2016

(54) PUDDING AND METHOD FOR MANUFACTURING SAME

(71) Applicant: KEWPIE CORPORATION, Tokyo (JP)

(72) Inventors: Nao OKADO, Chofu-shi, Tokyo (JP); Shoichi YODA, Chofu-shi, Tokyo (JP); Asa MORITA, Chofu-shi, Tokyo (JP)

(21) Appl. No.: 14/903,443

(22) PCT Filed: Jun. 16, 2014
(86) PCT No.: PCT/JP2014/065851

§ 371 Date: Jan. 7, 2016

(30) Foreign Application Priority Data
Jul. 8, 2013 (JP) 2013-143006

(51) Int. Cl. A23L 9/10; A23L 15/00

(52) U.S. Cl. CPC A23L 9/10; A23L 15/00; A23V 2002/00

(57) ABSTRACT

To provide a pudding having a smooth texture by a simple method, and a method for manufacturing the same, wherein in a pudding formulated with egg yolk and either milk or soy milk, a lysophospholipid and a free fatty acid are added so as to have a proportion of 0.05 parts or more and 5 parts or less of the free fatty acid based on 1 part of the lysophospholipid.

### TECHNICAL FIELD

The present invention relates to a pudding having a smooth texture by a simple method, wherein a lysophospholipid and a free fatty acid are added at a specific ratio, in a pudding formulated with egg yolk and one of milk and soy milk, and a method for manufacturing the same.

### BACKGROUND ART

A pudding is a western confectionery obtained by gelling a liquid mixture basically containing egg components, milk components, and saccharides, and has been supported by people of a wide range of ages since a long time ago.

Further, there are various formulations and recipes for a pudding, from a high class western confectionery shop to a generally distributed western confectionery. Recipes of such pudding can be roughly classified into “steamed pudding” and “gel pudding”.

Conventionally, in order to prepare a smooth pudding, the minute work such as that done by a patissier is necessary, and when a base of egg yolk is prepared, the important point is how to uniformly heat it.

Specifically, it requires an advanced technique of finely adjusting a heating temperature so as to entirely uniformly and sufficiently heat while paying attention also to small unevenness in denaturation of egg yolk protein caused when mixing with milk, sugar, and the like.

Therefore, a method for making a pudding having a smooth texture without requiring an advanced technique is required.

### CITATION LIST

### Patent Literatures

### Patent Literature 1: JP 4502874 B1

### Patent Literature 2: JP 7-289193 A

### Patent Literature 3: JP 2011-103860 A

### SUMMARY OF INVENTION

### Technical Problem

Therefore, an object of the present invention is to provide a pudding having a smooth texture by a simple method, and a method for manufacturing the same.

### Solution to Problem

As a result of repeated intensive studies to achieve the above object, the present inventors have found that, when a lysophospholipid and a free fatty acid are added at a specific ratio, in a pudding formulated with egg yolk and either milk or soy milk, a smooth texture is unexpectedly obtained by a simple method, thereby completing the present invention.

More specifically, according to the present invention, there are provided the following.

(1) A pudding formulated from egg yolk and one of milk and soy milk, wherein

a lysophospholipid and a free fatty acid are added so as to have a proportion of 0.05 parts or more and 5 parts or less (mass ratio) of the free fatty acid based on 1 part of the lysophospholipid.

(2) The pudding according to (1), wherein

80 percent or more of constituent fatty acids of the lysophospholipid is a saturation type, and

50 percent or more of the free fatty acid is an unsaturation type.

(3) The pudding according to (1) or (2), wherein

the addition amount of the lysophospholipid is 0.001% or more and 1% or less.

(4) A method for manufacturing the pudding as defined in any of (1) to (3), including:

a mixing step 1 of mixing a lysophospholipid and a free fatty acid with egg yolk; and

a mixing step 2 of mixing the mixed liquid obtained in the mixing step 1 with milk or soy milk.

(5) The method for manufacturing the pudding according to (4), wherein

mixing in the mixing step 1 is performed at least at 40° C. or more and 60° C. or less.

### Advantageous Effects of Invention

According to the present invention, a lysophospholipid and a free fatty acid are added at a specific ratio, in a pudding formulated with egg yolk and milk or soy milk, whereby a pudding having a smooth texture by a simple method and a method for manufacturing the same can be provided.

### DESCRIPTION OF EMBODIMENTS

Hereinbelow, the present invention will be described in detail. In the present invention, “%” means “% by mass”, and “part(s)” means “part(s) by mass”.

### <Characteristics of Present Invention>

The present invention is characterized by a pudding having a smooth texture by a simple method, wherein a lysophospholipid and a free fatty acid are added at a specific ratio, in a pudding formulated with egg yolk and either milk or soy milk.

Specifically, a lysophospholipid and a free fatty acid are added so as to have a proportion of 0.05 parts or more and 5 parts or less (mass ratio) of the free fatty acid based on 1 part of the lysophospholipid.

### <Pudding>

The pudding of the present invention refers to a so-called general pudding, and is not particularly limited, as long as egg yolk and one of milk and soy milk are used as raw materials.

Examples include a custard pudding cooked by steaming, a pudding cooled and coagulated by a gelling agent, and the like. Particularly, the present invention is suitable for a custard pudding, since the effect of the present invention is easily exhibited.

In addition, the present invention also encompasses a creme brulee that is similar to a custard pudding, an egg tart except for a part of tart pastry, and the like.

### <Egg Yolk>

The pudding of the present invention is formulated with egg yolk.

The egg yolk used in the present invention may be any yolk as long as it may be used for puddings, cakes and the like.

Examples include raw egg yolk or egg yolk liquid obtained by breaking a chicken egg and separating from egg white, dried egg yolk obtained by subjecting the raw egg yolk or egg yolk liquid to drying treatment such as spray dry and freeze dry, sugar-added egg yolk to which sugar is added to the raw egg yolk or egg yolk liquid, frozen egg yolk obtained by freezing the raw egg yolk or egg yolk liquid, the sugar-added egg yolk and the like, in addition, treated egg yolk subjected to desugaring treatment, sterilization treatment, enzyme treatment (for example, phospholipase A, protease, and the like), decholesterolization treatment or the like, and the like.

Further, in the present invention, those containing egg white within a range not impairing the effect of the present invention, for example, a whole egg, those subjected to the treatment described above and the like, can be also used. In this case, the egg yolk part of a whole egg corresponds to the egg yolk in the present invention.

### <Formulation Amount of Egg Yolk>

The formulation amount of egg yolk in the whole pudding of the present invention should be the amount generally formulated in a pudding.

Specifically, the formulation amount is preferably 5% or more and 50% or less, and further preferably 10% or more and 30% or less, in terms of raw egg yolk.

### <Milk>

The pudding of the present invention is formulated with milk or soy milk.

The milk used in the present invention is a milk containing at least milk protein, and examples include cow's milk, raw milk, or composition-adjusted processed milk obtained by adjusting components such as fat and iron contained in the milk, concentrated milk obtained by concentration, or whole milk powder, powdered skim milk, and the like.

### <Soy Milk>

The pudding of the present invention is formulated with milk or soy milk.

The soy milk used in the present invention is obtained by soaking soybeans in water, grinding them, adding water, and filtering the obtained liquid.

In addition, the soy milk in the present invention includes plain soy milk, composition-adjusted soy milk obtained by adjusting components such as fat and iron contained in soy milk, concentrated soy milk obtained by concentration, or one subjected to drying treatment, one obtained by grinding tofu, and the like.

### <Formulation Amount of Milk or Soy Milk>

The formulation amount of milk or soy milk in the whole pudding of the present invention should be an amount generally formulated in a pudding.

Specifically, the total formulation amount of milk and soy milk is preferably 4% or more and 11% or less, and further preferably 5% or more and 10% or less, in terms of solid content.

For example, when the amount in terms of solid content is converted for milk, 4% or more and 11% or less becomes 30% or more and 87% or less, and 5% or more and 10% or less becomes 40% or more and 80% or less.

### <Lysophospholipid>

The pudding of the present invention is formulated with a lysophospholipid as an essential component.

The lysophospholipid used in the present invention refers to monoacylglycerophospholipid.

Generally, a lysophospholipid is formed into a lyso-form in which one fatty acid of a phospholipid is cleaved, obtained by phospholipase A treatment of a phospholipid that is diacylglycerophospholipid extracted from animal and plant raw materials such as egg yolk, soybean, and rapeseed.

In addition, those obtained by the enzyme treatment of the animal and plant raw materials such as egg yolk and rapeseed directly with phospholipase A, followed by extraction by a conventional method, or those obtained by a synthesis method, further subjecting the obtained lysophospholipid to hydrogenation as necessary and the like are also included.

Examples of the lysophospholipid used in the present invention include lysophosphatidylcholine (LPC), lysophosphatidylethanolamnine (LPE), lysophosphatidylinositol (LPI), lysophosphatidic acid (LPA), lysophosphatidylserine (LPS), and the like, and one kind or two or more kinds of these lysophospholipids are preferably used in the present invention.

### <Free Fatty Acid>

The pudding of the present invention contains a free fatty acid as an essential component.

Many free fatty acids derived from animals and plants have a 10 or more and 24 or less carbon atoms.

The free fatty acid used in the present invention is also preferably one having a similar carbon number.

### <Proportion of Lysophospholipid and Free Fatty Acid>

In order to obtain a pudding having a smooth texture, the pudding of the present invention is necessary to have a proportion of 0.05 parts or more and 5 parts or less (mass ratio) of the free fatty acid based on 1 part of the lysophospholipid, and further preferably 0.1 parts or more and 2 parts or less.

When the mass ratio of the free fatty acid based on 1 part of the lysophospholipid is out of the above range, a pudding having a smooth texture is not obtained.

### <Kind of Constituent Fatty Acid of Lysophospholipid>

The constituent fatty acids of phospholipid extracted from animal and plant raw materials are a saturation type and an unsaturation type.

The constituent fatty acids of the lysophospholipid used in the present invention also may be either a saturation type or an unsaturation type, and 80 percent or more of the constituent fatty acids is preferably a saturation type since a pudding having a smooth texture is easily obtained.

As a lysophospholipid in which 80 percent or more of constituent fatty acids is a saturation type, representatively, a lysophospholipid derived from egg yolk is cited. Further, in the present invention, for example, those obtained by subjecting a plant-derived, for example, soybean lysophospholipid and the like, to hydrogenation can be also used.

### <Find of Free Fatty Acid>

The free fatty acids derived from animals and plants are a saturation type and an unsaturation type.

The free fatty acids used in the present invention may be also either a saturation type or an unsaturation type, and 50 percent or more of constituent fatty acids is preferably an unsaturated fatty acid since a pudding having a smooth texture is easily obtained.

### <Carbon Number of Constituent Fatty Acid of Lysophospholipid>

Many constituent fatty acids of phospholipid extracted from animal and plant raw materials have 10 or more and 24 or less carbon atoms.

The carbon number of the constituent fatty acid of the lysophospholipid used in the present invention is also preferably almost the same.

### <Formulation Amount of Lysophospholipid>

The addition amount of lysophospholipid in the pudding of the present invention is preferably 0.001% or more and further preferably 0.005% or more, since a pudding having a smooth texture is easily obtained by using in combination with the free fatty acid described above.

Here, the upper limit is not defined, but even when added in an amount of more than 1%, the effect of the present invention corresponding to the addition amount is difficult to obtain, and thus is not economical, therefore, the upper limit of the addition amount of lysophospholipid is preferably 1%.

### <Oils and Fats Simultaneously Containing Lysophospholipid and Free Fatty Acid>

The pudding of the present invention is formulated with a lysophospholipid and a free fatty acid as essential components, and each component may be prepared and added. Further, oils and fats simultaneously containing these essential components, or simultaneously containing these essential components and other lipid components such as triglyceride (TG) may be used.

Here, as the lysophospholipid and free fatty acid added to the pudding of the present invention, a lysophospholipid and fatty acid exist as a lipoprotein that is a complex with a protein such as phospholipase A-treated egg yolk and the like are not included.

### <Other Raw Materials>

A food material other than the egg yolk, milk, soy milk, lysophospholipid and free fatty acid described above can be properly added to the pudding of the present invention, within a range not impairing the effect of the present invention.

Specifically, other food material includes a gelling agent such as agar, carrageenan, furcellaran, gelatin, low methoxyl pectin, deacylation gellan gum or sodium alginate, saccharides such as granulated sugar, soft white sugar, soft brown sugar, brown cane sugar and honey, oils and fats such as fresh cream, animal and vegetable oils and cholesterol, various additives such as vanilla beans and vanilla essence, thickeners, emulsifiers, alcohols, and the like.

Further, the pudding of the present invention may be topped with caramel source, fresh cream, fruits and the like, as necessary.

### <Method for Manufacturing Pudding>

A pudding is generally prepared by gelling a liquid mixture containing egg yolk, milk, and soy milk that are pudding raw materials, and other raw materials.

The pudding of the present invention should be prepared by homogeneously mixing a lysophospholipid and a free fatty acid that are essential components of the present invention with the liquid mixture described above.

Particularly, the pudding of the present invention is preferably produced by the following method since the effect of the present invention is easily obtained.

Specifically, a method for manufacturing the pudding including a mixing step 1 of mixing a lysophospholipid and a free fatty acid with egg yolk and a mixing step 2 of mixing the mixed liquid obtained in the mixing step 1 with milk or soy milk is preferable.

Furthermore, it is preferred that mixing in the mixing step 1 is performed at least at 40° C. or more.

And, the mixing is preferably performed at 60° C. or less, considering coagulation of egg yolk.

Next, the present invention will be further described based on comparative examples and test examples. The present invention is not limited to these examples.

### EXAMPLES

### Example 1

### (1) Preparation of Liquid Mixture of Pudding Raw Materials

A liquid mixture of pudding raw materials used in Example 1 was prepared.

Specifically, an egg yolk lysophospholipid and a mixed free fatty acid were homogeneously mixed and stirred with raw egg yolk while heating to 45° C. (mixing step 1).

Next, granulated sugar and milk were added to the mixed liquid described above, and the mixture was homogeneously mixed and stirred, followed by filtration to prepare a mix liquid of pudding raw materials (mixing step 2)

The proportion of the lysophospholipid to the free fatty acid is 0.5 parts of the free fatty acid based on 1 part of the lysophospholipid.

| | |
|---|---|
| Raw egg yolk | 20% |
| Granulated sugar | 10% |
| Egg yolk lysophospholipid | 0.1% |
| Mixed free fatty acid | 0.05% |

100% with milk (8.8% in terms of solid content)

Egg yolk lysophospholipid (lysophospholipid almost 100%. containing LPC and LPE. 80 percent or more is a saturation type. manufactured by Kewpie Corporation)
Mixed free fatty acid (mixture of free fatty acids having 14 to 18 carbon atone. 50 percent or more an unsaturation type.) Milk (solid content of 12.6%)

### (2) Molding of Pudding

A pudding was prepared using the liquid mixture of pudding raw materials obtained in (1).

Specifically, the liquid mixture of pudding raw materials in (1) was filled in a heat-resistant cap, then heated and coagulated in a steamer at 85° C. for 30 minutes to prepare a pudding of the present invention.

### Example 2

A pudding of Example 2 was prepared by the same manufacturing method as in Example 1, changing the addition amount of the egg yolk lysophospholipid to 0.5%.

The proportion of the lysophospholipid to the free fatty acid is 0.1 parts of the free fatty acid based on 1 part of the lysophospholipid.

### Example 3

A pudding of Example 3 was prepared by the same manufacturing method as in Example 1, changing the addition amount of the egg yolk lysophospholipid to 0.06% and the addition amount of the mixed free fatty acid to 0.06%.

The proportion of the lysophospholipid to the free fatty acid is 1 part of the free fatty acid based on 1 part of the lysophospholipid.

### Example 4

A pudding of Example 4 was prepared by the same manufacturing method as in Example 1, changing the addition amount of the egg yolk lysophospholipid to 0.003% and the addition amount of the mixed free fatty acid to 0.009%.

The proportion of the lysophospholipid to the free fatty acid is 3 parts of the free fatty acid based on 1 part of the lysophospholipid.

### Example 5

A pudding of Example 5 was prepared by the same manufacturing method as in Example 1, changing the addition amount of the egg yolk lysophospholipid to 0.004% and the addition amount of the mixed free fatty acid to 0.0002%.

The proportion of the lysophospholipid to the free fatty acid is 0.05 parts of the free fatty acid based on 1 part of the lysophospholipid.

### Comparative Example 1

A pudding of Comparative Example 1 was prepared by the same manufacturing method as in Example 1, except without adding an egg yolk lysophospholipid and a mixed free fatty acid as in Example 1.

### Comparative Example 2

A pudding of Comparative Example 2 was prepared by the same manufacturing method as in Example 1, except without adding an egg yolk lysophospholipid, and changing the addition amount of the mixed free fatty acid to 0.1%.

### Comparative Example 3

A pudding of Comparative Example 3 was prepared by the same manufacturing method as in Example 1, changing the addition amount of the egg yolk lysophospholipid to 0.001% and the addition amount of the mixed free fatty acid to 0.01%.

The proportion of the lysophospholipid to the free fatty acid is 10 parts of the free fatty acid based on 1 part of the lysophospholipid.

### Comparative Example 4

A pudding of Comparative Example 4 was prepared by the same manufacturing method as in Example 1, changing the addition amount of the egg yolk lysophospholipid to 0.002% and the addition amount of the mixed free fatty acid to 0.00001%.

The proportion of the lysophospholipid to the free fatty acid is 0.005 parts of the free fatty acid based on 1 part of the lysophospholipid.

### Test Example 1

The effects on smoothness of a pudding by the addition of the lysophospholipid and the free fatty acid that are essential components and by the formulation proportion were investigated.

Specifically, the puddings prepared in Examples 1 to 5 and Comparative Examples 1 to 4 were each eaten to evaluate smoothness on the basis of the pudding prepared in Comparative Example 1.

The evaluation is in accordance with the following evaluation standard.

⊚: Has a much smoother texture than the pudding prepared in Comparative Example 1.
◯: Has a smoother texture than the pudding prepared in Comparative Example 1.
Δ: Has a little smoother texture than the pudding prepared in Comparative Example 1.
x: Has the same level of texture as the pudding prepared in Comparative Example 1.

TABLE 1

| | Comp. | | | | | | Comp. | Comp. |
|---|---|---|---|---|---|---|---|---|
| Pudding | Ex. 3 | Ex. 4 | Ex. 3 | Ex. 1 | Ex. 2 | Ex. 5 | Ex. 4 | Ex. 2 |
| Ratio of | 1:10 | 1:3 | 1:1 | 1:0.5 | 1:0.1 | 1:0.05 | 1:0.005 | Only |
| Lysophospholipid | | | | | | | | free |
| to Free | | | | | | | | fatty |
| Fatty Acid | | | | | | | | acid |
| | | | | | | | | is |
| | | | | | | | | added |
| Evaluation | X | ◯ | ⊙ | ⊙ | ⊙ | ◯ | X | X |

It can be understood from Table 1 that a pudding having a smooth texture is not obtained unless the proportion of the lysophospholipid to the free fatty acid is 0.05 parts or more and 5 parts or less of the free fatty acid based on 1 part of the lysophospholipid (Examples 1 to 5).

Particularly, when the proportion of the lysophospholipid to the free fatty acid was 0.1 parts or more and 2 parts or less of the free fatty acid based on 1 part of the lysophospholipid, the effect of the present invention was remarkably exhibited (Examples 1 to 3).

### Example 6

A pudding of Example 6 was prepared by the same formulation and manufacturing method as in Example 1, adding a hydrogenated soy lysophospholipid in place of the egg yolk lysophospholipid of Example 1.

Here, the hydrogenated soy lysophospholipid contains lysophospholipid in an amount of almost 100%, contains LPC, LPE, LPI and LPA, and the kind of constituent fatty acids is a saturation type in 80 percent or more.

### Example 7

A pudding of Example 7 was prepared by the same formulation and manufacturing method as in Example 1, adding an unhydrogenated soy lysophospholipid in place of the egg yolk lysophospholipid of Example 1.

Here, in the unhydrogenated soy lysophospholipid, the kind of constituent fatty acids is a saturation type in 30 percent, and an unsaturation type in 70 percent.

### Example 8

A pudding of Example 8 was prepared by the same formulation and manufacturing method as in Example 1, adding a stearic acid in place of the mixed free fatty acid of Example 1.

### Test Example 21

The effects on smoothness of a pudding by the kind of the lysophospholipid and the kind of the free fatty acid were investigated.

Specifically, the puddings prepared in Examples 1 and 6 to 8 were each eaten to evaluate smoothness on the basis of the pudding prepared in Comparative Example 1.

TABLE 2

| | Ex. 1 | Ex. 6 | Ex. 7 | Ex. 8 |
|---|---|---|---|---|
| Lysophospholipid | egg yolk | hydrogenated soy | unhydrogenated | egg yolk |
| | lysophospholipid | lysophospholipid | soy | lysophospholipid |
| | (saturation type | (saturation type | lysophospholipid | (saturation type |
| | 80% or more) | 80% or more) | (saturation type | 80% or more) |
| | | | less than 80%) | |
| Free fatty acid | Mixed free fatty | Mixed free fatty | Mixed free fatty | Stearic acid |
| | acid | acid | acid | |
| | (unsaturation | (unsaturation | (unsaturation | |
| | type 50% or more) | type 50% or more) | type 50% or more) | |
| Evaluation | ⊙ | ⊙ | ◯ | ◯ |

It can be understood from Table 2 that a smooth texture is easily obtained when 80 percent or more of the constituent fatty acid of lysophospholipid is a saturation type, and 50 percent or more of the free fatty acid is an unsaturation type (Examples 1 and 6).

### Example 9

A pudding was prepared by the same formulation proportion as in Example 1.

An egg yolk lysophospholipid and a mixed free fatty acid were homogeneously mixed and stirred with milk while heating to 45° C. (mixing step 1).

Next, granulated sugar and raw egg yolk were added to the mixed liquid described above, and the mixture was homogeneously mixed and stirred, followed by filtration to prepare a mix liquid of pudding raw materials (mixing step 2).

Using the mix liquid of pudding raw materials described above, the pudding of Example 9 was prepared by the same molding method as in Example 1.

### Example 10

A pudding was prepared by the same formulation proportion as in Example 1.

An egg yolk lysophospholipid and a mixed free fatty acid were added while heating a mixed liquid of raw egg yolk, milk and granulated sugar to 45° C., and the mixture was homogeneously mixed and stirred, followed by filtration to prepare a mix liquid of pudding raw materials (mixing step 1).

Using the mix liquid of pudding raw materials described above, the pudding of Example 10 was prepared by the same molding method as in Example 1.

### Test Example 3

The effects on smoothness of a pudding by changing the mixing step in the pudding of the present invention were investigated.

The puddings prepared in Examples 1, 9 and 10 were each eaten to evaluate smoothness on the basis of the pudding prepared in Comparative Example 1.

TABLE 3

| | Ex. 1 | Ex. 9 | Ex. 10 |
|---|---|---|---|
| Mixing step 1 | Mixing | Mixing | Mixing |
| | lysophospholipid | lysophospholipid | lysophospholipid |
| | and free fatty | and free fatty | and free fatty |
| | acid with egg | acid with milk | acid with a mixed |
| | yolk | | liquid of egg |
| | | | yolk and milk |
| Evaluation | ⊙ | ◯ | ◯ |

It can be understood from Table 3 that a smooth texture is easily obtained in the manufacturing method including a mixing step 1 of previously mixing a lysophospholipid and a free fatty acid with egg yolk (Example 1).

### Example 11

A pudding of Example 11 was prepared by the same formulation and manufacturing method as in Example 1, except for changing from 45° C. to 55° C. in the mixing step 1, in the preparation of the liquid mixture of pudding raw materials in Example 1.

### Example 12

A pudding of Example 12 was prepared by the same formulation and manufacturing method as in Example 1, except for performing the mixing step 1 without heating, in the preparation of the liquid mixture of pudding raw materials in Example 1.

### Test Example 4

The effects on smoothness by the temperature in the mixing step 1, in the preparation of the mix liquid of pudding raw materials of the present invention, were investigated.

The puddings prepared in Examples 1, 11 and 12 were each eaten to evaluate smoothness on the basis of the pudding prepared in Comparative Example 1.

TABLE 4

| | Ex. 1 | Ex. 11 | Ex. 12 |
|---|---|---|---|
| Mixing | 45° C. | 55° C. | Unheated |
| Temperature | | | |
| (° C.) | | | |
| Evaluation | ⊙ | ⊙ | ◯ |

It can be understood from Table 4 that a smooth texture is easily obtained when mixing in the mixing step 1 is performed at least at 40° C. or more and 60° C. or less (Examples 1 and 11).

### Example 13

A pudding of Example 13 was prepared by the same manufacturing method as in Example 1, except for replacing milk with soy milk (solid content of 8%), in Example 1.

The formulation amount of soy milk in the pudding is 5.8% in terms of solid content.

When the resulting pudding was eaten to evaluate smoothness on the basis of the pudding prepared in Comparative Example 1, the pudding had a very smooth texture as same as the pudding obtained in Example 1.

### Example 14

### (1) Preparation of Mix Liquid of Pudding Raw Materials

A mix liquid of pudding raw materials used in Example 14 was prepared.

Specifically, an egg yolk lysophospholipid and a mixed free fatty acid were homogeneously mixed and stirred with egg yolk oil while heating to 45° C. to previously prepare a mixed oil and fat.

Next, the mixed oil and fat described above was homogeneously mixed and stirred with raw egg yolk while heating to 45° C. (mixing step 1).

Furthermore, granulated sugar and milk were added to the mixed liquid obtained in the mixing step 1, and the mixture was homogeneously mixed and stirred, followed by filtration to prepare a mix liquid of pudding raw materials (mixing step 2).

Using the mix liquid of pudding raw materials described above, the pudding of Example 14 was prepared by the same molding method as in Example 1.

When the resulting pudding was eaten to evaluate smoothness on the basis of the pudding prepared in Comparative Example 1, the pudding had a very smooth texture, as same as the pudding obtained in Example 1.

| | |
|---|---|
| Raw egg yolk | 20% |
| Granulated sugar | 10% |
| Egg yolk oil | 0.4% |
| Egg yolk lysophospholipid | 0.1% |
| Mixed free fatty acid | 0.05% |

100% with milk (8.8% in terms of solid content)
Egg yolk oil (TG in almost 100%.)

Here, when the same test was performed in Examples 13 and 14 as in Test Examples 1 to 4, the result was same as in the puddings obtained in Examples 1 to 12.

### Comparative Example 5

A pudding of Comparative Example 5 was prepared by the same manufacturing method as in Example 1, adding 0.1% of egg yolk phospholipid in place of the egg yolk lysophospholipid and the mixed free fatty acid of Example 1.

Here, the egg yolk phospholipid contains phospholipid in an amount of almost 100%, contains phosphatidylcholine (PC) and phosphatidylethanol (PE), and is manufactured by Kewpie Corporation.

When the resulting pudding was eaten to evaluate smoothness on the basis of the pudding prepared in Comparative Example 1, the pudding had a little smooth texture, but did not come up to expectations.

1. A pudding formulated from egg yolk and one of milk and soy milk, wherein
a lysophospholipid and a free fatty acid are added so as to have a proportion of 0.05 parts or more and 5 parts or less (mass ratio) of the free fatty acid based on 1 part of the lysophospholipid.

2. The pudding according to claim 1, wherein
80 percent or more of constituent fatty acids of the lysophospholipid is a saturation type, and
50 percent or more of the free fatty acid is an unsaturation type.

3. The pudding according to claim 1 or 2, wherein
the addition amount of the lysophospholipid is 0.001% or more and 1% or less.

4. A method for manufacturing the pudding as defined in any of claims 1 to 3, comprising:
a mixing step 1 of mixing a lysophospholipid and a free fatty acid with egg yolk; and
a mixing step 2 of mixing the mixed liquid obtained in the mixing step 1 with milk or soy milk.

5. The method for manufacturing the pudding according to claim 4, wherein
mixing in the mixing step 1 is performed at least at 40° C. or more and 60° C. or less.
